(19) United States
(12) Patent Application Publication
(10) Pub. No.: US 2015/0171454 A1
(43) Pub. Date: Jun. 18, 2015

(54) MEMBRANE WITH LAMINATED STRUCTURE AND ORIENTATION CONTROLLED NANOFIBER REINFORCEMENT ADDITIVES FOR FUEL CELLS

(71) Applicant: GM Global Technology Operations LLC, Detroit, MI (US)

(72) Inventors: Ruichun JIANG, Rochester, NY (US); Timothy J. FULLER, Pittsford, NY (US); Craig S. GITTLEMAN, Rochester, NY (US)

(21) Appl. No.: 14/628,898

(22) Filed: Feb. 23, 2015

Related U.S. Application Data
(63) Continuation of application No. 13/186,923, filed on Jul. 20, 2011.

(51) Int. Cl. H01M 8/10

(52) U.S. Cl. CPC H01M 8/1053; H01M 8/1023; H01M 8/1025; H01M 8/1051; H01M 8/1039; H01M 2300/0094; H01M 2300/0082; H01M 2008/1095

(57) ABSTRACT

An ion-conducting membrane for fuel cell applications a first layer including a first ion-conducting polymer and nanofibers dispersed therein. The first layer includes a first side and a second side. A second layer is disposed over the first side of the first layer and includes a second ion-conducting polymer without nanofibers.

### CROSS-REFERENCE TO RELATED APPLICATIONS

This application is a continuation of U.S. application Ser. No. 13/186,923 filed Jul. 20, 2011, the disclosure of which is hereby incorporated in its entirety by reference herein.

### FIELD OF THE INVENTION

In at least one aspect, the present invention relates to polymer electrolytes and fuel cells incorporating such polymeric electrolytes.

### BACKGROUND OF THE INVENTION

Fuel cells are electrochemical conversion cells that produce electrical energy by processing reactants, for example, through the oxidation and reduction of hydrogen and oxygen. Durability is one of the factors that determine the commercial viability of a fuel cell. For example, a vehicle fuel cell needs to last at least 5,000 hours. Such a high durability requirement challenges the polymeric electrolyte membrane (PEM) materials under consideration for a fuel cell. Mechanical failure is one of the major failure modes for fuel cell membranes.

To improve fuel cell membrane mechanical stability, currently one of the major focuses in the fuel cell industry is to develop an internally reinforced membrane. A typical example of such an internally reinforced membrane is one that has an expanded Polytetrafluoroethylene (ePTFE) layer, in a continuous network form, inside of the membrane to enhance its mechanical properties. ((1). S. Cleghorn, J. Kolde, W. Liu, in: Vielstich, W., Gasteiger, H., and Lamm, A. (Eds.), Handbook of Fuel Cells Volume 3: Fundamentals, Technology and Applications, John Wiley & Sons, New York, 2003, pp. 566-575. (2). F. Q. Liu, B. L. Yi, D. M. Xing, J. R. Yu, H. M. Zhang, J. Membr. Sci. 212 (2003) 213-223.) The ePTFE layer significantly increases the through-plane resistance of the membrane and thus decreases fuel cell performance.

A new strategy is provided in this invention to incorporate nanofiber (NF) reinforcement additives in fuel cell membranes for improving membrane mechanical durability. The new membrane fabrication technique includes laminated membrane structure and orientation controlled nanofiber reinforcement additives. The laminated membrane has a multilayer structure consisting of reinforced layers and non-reinforced layers. Nanofiber additives are introduced in the reinforced layers of the membrane, and the orientation of the nanofiber is controlled in the preferred in-plane direction. Pure ionomer materials are applied to form the non-reinforced layers of the membrane. The obtained state-of-art membrane is such that membranes demonstrate reduced in-plane swelling and improved durability in fuel cell testings with smaller resistance sacrifice.

### SUMMARY OF THE INVENTION

In at least one embodiment, the present invention solves one or more problems of the prior art by providing an ion-conducting membrane for a fuel cell application. The ion-conducting membrane comprises a first layer including a first ion-conducting polymer and nanofibers dispersed therein. The first layer includes a first side and a second side. A second layer is disposed over the first side of the first layer and includes a second ion-conducting polymer without nanofibers.

In another embodiment, a membrane electrode assembly for fuel cells in provided. The membrane electrode assembly includes an anode layer; a cathode layer, and an ion-conducting membrane interposed between the anode layer and the cathode layer. The ion-conducting membrane comprises a first layer including a first ion-conducting polymer and nanofibers dispersed therein. The first layer includes a first side and a second side. A second layer is disposed over the first side of the first layer and includes a second ion-conducting polymer without nanofibers.

### BRIEF DESCRIPTION OF THE DRAWINGS

FIG. 1 provides a schematic illustration incorporating membranes with a fiber-containing layer;

FIG. 2 provides a schematic to make a multilayer membrane with reinforced and non-reinforced layers;

FIG. 3 shows the in-plane (biaxial) swelling of membranes without and with reinforced layer containing various loadings of nanofiber additives, after 24 hr at 80° C. with liquid deionized (DI) water(NF stands for nanofiber, and RL stands for reinforced layer).

FIG. 4 shows the tortuosity on H⁺ transport of reinforced layer with various loadings of nanofiber additives inside, together with comparison sample with a continuous ePTFE network additive inside of the reinforced layer;

FIG. 5 shows the measured crossover leak rate as a function of relative humidity (RH) cycles during the fuel cell durability tests; and

FIG. 6 show the SEM images of the cross sections of the two MEAs after fuel cell durability tests through RH cycling. (a). without reinforced layer in the membrane. (b). with reinforced layer containing nanofiber additives in the membrane.

### DESCRIPTION OF THE INVENTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the term “polymer” includes “oligomer,” “copolymer,” “terpolymer,” “block”, “random,” “segmented block,” and the like; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

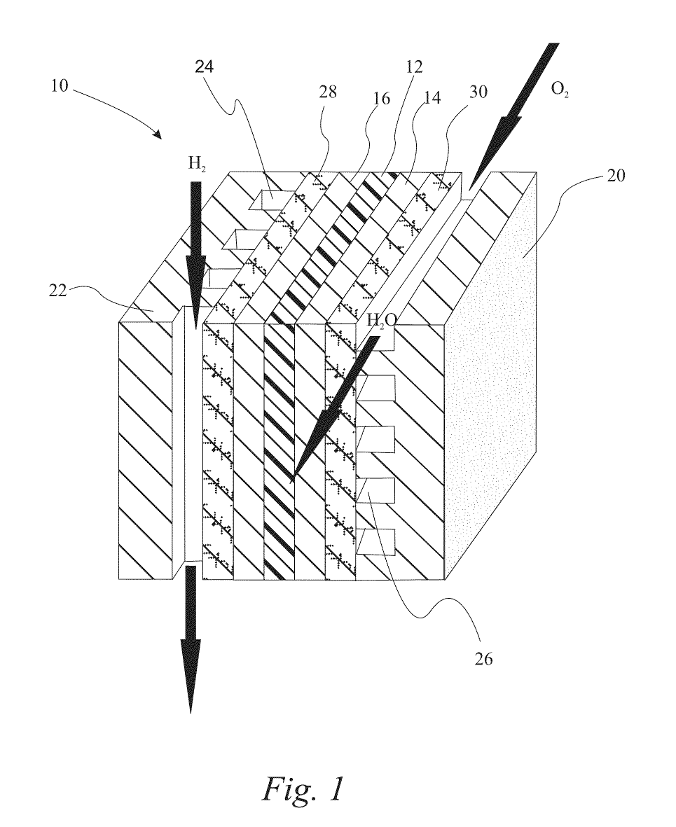

With reference to FIG. 1, a fuel cell that incorporates a polymeric electrolyte including polymers from the invention is provided. PEM fuel cell 10 includes polymeric ion conductive membrane 12 disposed between cathode catalyst layer 14 and anode catalyst layer 16. Collectively, polymeric ion conductive membrane 12, cathode catalyst layer 14 and anode catalyst layer 16 are referred to as the membrane electrode assembly (MEA). Polymeric ion conductive membrane 12 includes one or more of the polymers that include fibers as set forth below. Fuel cell 10 also includes conductive plates 20, 22, gas channels 24 and 26, and gas diffusion layers 28 and 30.

In an embodiment, an ion-conducting multilayer membrane for fuel cell applications is provided. In general, the ion-conducting membrane comprises a first layer including a first ion-conducting polymer (i.e., an ionomer) and fibers (or nanofibers) dispersed therein. The first layer includes a first side and a second side. A second layer is disposed over the first side of the first layer and includes a second ion-conducting polymer without fibers (or nanofibers). In some variations as set forth below, the multilayer membrane further includes a third layer disposed over and typically contacting the second side of the first layer, the third layer including a third ion-conducting polymer without nanofibers. In other variations, the third layer includes a third ion-conducting polymer with fibers (or nanofibers) with the fibers (or nanofibers) being dispersed within the third ion-conducting polymer.

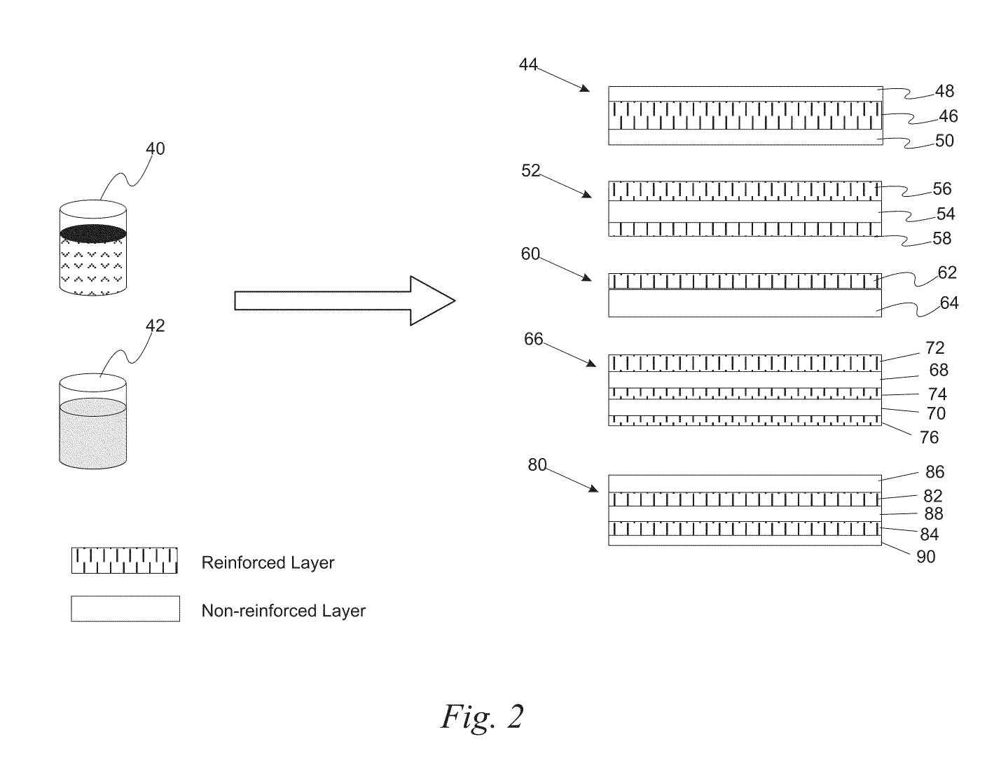

With reference to FIG. 2, a schematic illustration of various configurations using a fiber-reinforced layer is provided. The multilayer membranes in FIG. 2 are depicted as cross sections. In general, the multilayer membranes are plate-like or planar. The ion-conducting membranes are formed from polymer solution 40 which includes an ionomer and fibers, and from solution 42 which includes an ionomer but no fibers. In multilayer membrane 44, fiber-containing layer 46 is disposed between layers 48 and 50 each of which does not include fibers. In multilayer membrane 52, fiber-free layer 54 is disposed between fiber-containing layers 56 and 58. In multilayer membrane 60, fiber-containing layer 62 is disposed over and typically contacts fiber-free layer 64. In multilayer membrane 66, fiber-free layers 68 and 70 are disposed between fiber-containing layers 72, 74, 76. In multilayer membrane 80, fiber-containing layers 82 and 84 are disposed between fiber-free layers 86, 88, 90.

The multilayer membranes of various embodiments of the invention have layers that include an ionomer and fibers' in particular, nanofibers and layers that include an ionomer without any fibers. In a variation, both the fiber-containing layers and the fiber-free layers each independently include a component selected from the group consisting of perfluorosulfonic acid polymer, hydrocarbon based ionomer, sulfonated polyether ether ketone polymer, perfluorocyclobutane polymers, and combinations thereof.

In a variation, the fibers, and in particular, the nanofibers, are polymeric fibers (or nanofibers) or inorganic fibers (or nanofibers). In a refinement, the nanofibers comprise a component selected from the group consisting of polyvinylidene fluoride, polyester, and combinations thereof. In a refinement, the fibers (or nanofibers) comprise a component selected from the group consisting of carbon, metal, ceramic oxide/composites, CeO₂, MnO₂, TiO₂, ZrO₂, SiO₂, Al₂O₂, ZrCeO₂, and combinations thereof. In another refinement, the fiber (or nanofibers) have a continuous web configuration. In yet another refinement, the fibers (or nanofibers) comprise discrete individual fibers. Moreover, it should also be appreciated that the fibers (or nanofibers) may be electrically conductive or electrically non-conductive. Advantageously, the fiber-containing layers have a moisture-induced swelling less than about 10 percent.

The fibers in the embodiments and variations set forth above are typically nanofibers because these fibers have an average diameter from about 5 nm to 10 μm. Typically, the fibers have an average length greater than about 10 nm.

In a variation, the fiber-containing layers include fibers (or nanofibers) in an amount from about 1 to about 50 weight percent of the total weight of the first layer.

In another refinement, the nanofibers have an in-plane oriention. This means that lengths of the fibers (or nanofibers) preferentially lay parallel to the surface layers in which they are contained.

In certain embodiments, the fiber-containing layers and the fiber-free layers set forth above may each include a polymer having perfluorocyclobutyl groups. Suitable polymers having cyclobutyl moieties are disclosed in U.S. Pat. Pub. No. 2007/0099054, U.S. patent application Ser. No. 12/197,530 filed Aug. 25, 2008; Ser. No. 12/197,537 filed Aug. 25, 2008; Ser. No. 12/197,545 filed Aug. 25, 2008; and Ser. No. 12/197,704 filed Aug. 25, 2008; the entire disclosures of which are hereby incorporated by reference. In a variation, the cyclobutyl-containing polymers have a polymer segment comprising polymer segment 1:

E₀-P₁-Q₁-P₂ 1

wherein:
Eₒ is a moiety having a protogenic group such as —SO₂X, —PO₃H₂, —COX, and the like;
P₁, P₂ are each independently absent, —O—, —S—, —SO—, —CO—, —SO₂—, —NH—, NR₂—, or
R₂ is C₁₋₂₅ alkyl, C₁₋₂₅ aryl or C₁₋₂₅ arylene;
R₃ is C₁₋₂₅ alkylene, C₁₋₂₅ perfluoroalkylene, perfluoroalkyl ether, alkylether, or C₁₋₂₅ arylene;
X is an —OH, a halogen, an ester, or

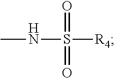

R₄ is trifluoromethyl, C₁₋₂₅ alkyl, C₁₋₂₅ perfluoroalkylene, C₁₋₂₅ aryl, or E₁(see below); and
Q₁ is a fluorinated cyclobutyl moiety. In a refinement, polymer segment 1 is repeated 1 to 10,000 times.

In variation of the present invention, the cyclobutyl-containing polymers comprise polymer segments 2 and 3:

[E₁(Z₁)_{d}]-α₁-Q₁-P₂ 2

E₂-P₃-Q₂-P₄ 3

wherein:
Z₁ is a protogenic group such as —SO₂X, —PO₃H₂, —COX, and the like;
E₁ is an aromatic containing moiety;
E₂ is an unsulfonated aromatic-containing and/or aliphatic-containing moiety;
X is an —OH, a halogen, an ester, or

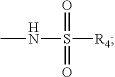

d is the number of Z₁ attached to E₁;
P₁, P₂, P₃, P₄ are each independently absent, —O—, —S—, —SO—, —CO—, —SO₂—, —NH—, NR₂—, or —R₃—;
R₂ is C₁₋₂₅ alkyl, C₁₋₂₅ aryl, or C₁₋₂₅ arylene;
R₃ is C₁₋₂₅ alkylene, C₁₋₂₅ perfluoroalkylene, perfluoroalkyl ether, alkylether, or C₁₋₂₅ arylene;
R₄ is trifluoromethyl, C₁₋₂₅ alkyl, C₁₋₂₅ perfluoroalkylene, C₁₋₂₅ aryl, or another E₁ group; and
Q₁, Q₂ are each independently a fluorinated cyclobutyl moiety. In one refinement, d is equal to the number of aromatic rings in E₁. In another refinement, each aromatic ring in E₁ can have 0, 1, 2, 3, or 4 Z₁ groups.

In another variation of the present embodiment, the cyclobutyl-containing polymers comprise segments 4 and 5:

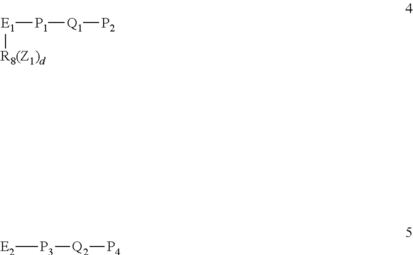

wherein:
Z₁ is a protogenic group such as —SO₂X, —PO₃H₂, —COX, and the like;
E₁, E₂ are each independently an aromatic-containing and/or aliphatic-containing moiety;
X is an —OH, a halogen, an ester, or

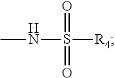

d is the number of Z₁ attached to R₈;
P₁, P₂, P₃, P₄ are each independently absent, —O—, —S—, —SO—, —CO—, —SO₂—, —NH—, NR₂—, or —R₃—;
R₂ is C₁₋₂₅ alkyl, C₁₋₂₅ aryl or C₁₋₂₅ arylene;
R₃ is C₁₋₂₅ alkylene, C₁₋₂₅ perfluoroalkylene, perfluoroalkyl ether, alkylether, or C₁₋₂₅ arylene;
R₄ is trifluoromethyl, C₁₋₂₅ alkyl, C₁₋₂₅ perfluoroalkylene, C₁₋₂₅ aryl, or another E₁ group;
R₈(Z₁)_{d} is a moiety having d number of protogenic groups; and
Q₁, Q₂ are each independently a fluorinated cyclobutyl moiety. In a refinement of this variation, R⁸ is C₁₋₂₅ alkylene, C₁₋₂₅ perfluoroalkylene, perfluoroalkyl ether, alkylether, or C₁₋₂₅ arylene. In one refinement, d is equal to the number of aromatic rings in R₈. In another refinement, each aromatic ring in R₈ can have 0, 1, 2, 3, or 4 Z₁ groups. In still another refinement, d is an integer from 1 to 4 on average;

In another variation, the cyclobutyl-containing polymers comprise segments 6 and 7:

E₁(SO₂X)_{d}—P₁-Q₁-P₂ 6

E₂-P₃-Q₂-P₄ 7

connected by a linking group L₁ to form polymer units 8 and 9:

E₂-P₃-Q₂-P₄ⱼL₁E₁(SO₂X)_{d}—P₁-Q₁-P₂ᵢ 8

E₁(Z₁)_{d}—P₁-Q₁-P₂ᵢL₁E₂-P₃-Q₂-P₄ⱼ 9

wherein:
Z₁ is a protogenic group such as —SO₂X, —PO₃H₂, —COX, and the like;
E₁ is an aromatic-containing moiety;
E₂ is an unsulfonated aromatic-containing and/or aliphatic-containing moiety;
L₁ is a linking group;
X is an —OH, a halogen, an ester, or

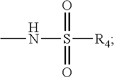

d is a number of Z₁ functional groups attached to E₁;
P₁, P₂, P₃, P₄ are each independently absent, —O—, —S—, —SO—, —SO₂—, —CO—, —NH—, NR₂—, or —R₃—, and
R₂ is C₁₋₂₅ alkyl, C₁₋₂₅ aryl or C₁₋₂₅ arylene;
R₃ is C₁₋₂₅ alkylene, C₁₋₂₅ perfluoroalkylene, or C₁₋₂₅ arylene;
R₄ is trifluoromethyl, C₁₋₂₅ alkyl, C₁₋₂₅ perfluoroalkylene, C₁₋₂₅ aryl, or another E₁ group;
Q₁, Q₂ are each independently a fluorinated cyclobutyl moiety;
i is a number representing the repetition of polymer segment 6 with i typically from 1 to 200; and
j is a number representing the repetition of a polymer segment 7 with j typically being from 1 to 200. In one refinement, d is equal to the number of aromatic rings in E₁. In another refinement, each aromatic ring in E₁ can have 0, 1, 2, 3, or 4 Z₁ groups. In still another refinement, d is an integer from 1 to 4 on average.

In still another variation, the cyclobutyl-containing polymers comprise polymer segments 10 and 11:

E₁(Z₁)_{d}—P₁-Q₁-P₂ 10

E₂(Z₁)_{f}—P₃ 11

wherein:
Z₁ is a protogenic group such as —SO₂X, —PO₃H₂, —COX, and the like;
E₁, E₂ are each independently an aromatic or aliphatic-containing moiety wherein at least one of E₁ and E₂ includes an aromatic substituted with Z₁;
X is an —OH, a halogen, an ester, or

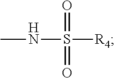

d is the number of Z₁ functional groups attached to E₁;
f is the number of Z₁ functional groups attached to E₂;
P₁, P₂, P₃ are each independently absent, —O—, —S—, —SO—, —SO₂—, —CO—, —NH—, NR₂—, or —R₃—;
R₂ is C₁₋₂₅ alkyl, C₁₋₂₅ aryl, or C₁₋₂₅ arylene;
R₃ is C₁₋₂₅ alkylene, C₁₋₂₅ perfluoroalkylene, perfluoroalkyl ether, alkyl ether, or C₁₋₂₅ arylene;
R₄ is trifluoromethyl, C₁₋₂₅ alkyl, C₁₋₂₅ perfluoroalkylene, C₁₋₂₅ aryl, or another E₁ group; and
Q₁ is a fluorinated cyclobutyl moiety,
with the proviso that when d is greater than zero, f is zero and when f is greater than zero d is zero. In one refinement, d is equal to the number of aromatic rings in E₁. In another refinement, each aromatic ring in E₁ can have 0, 1, 2, 3, or 4 Z₁ groups. In still another refinement, d is an integer from 1 to 4 on average. In one refinement, f is equal to the number of aromatic rings in E₂. In another refinement, each aromatic ring in E₂ can have 0, 1, 2, 3, or 4 Z₁ groups. In still another refinement, f is an integer from 1 to 4 on average.

Examples for Q₁ and Q₂ in the above formulae are:

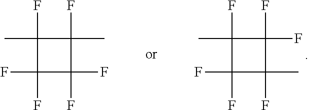

In each of the formulae 2-11, E₁ and E₂ include one or more aromatic rings. For example, E₁ and E₂, include one or more of the following moieties:

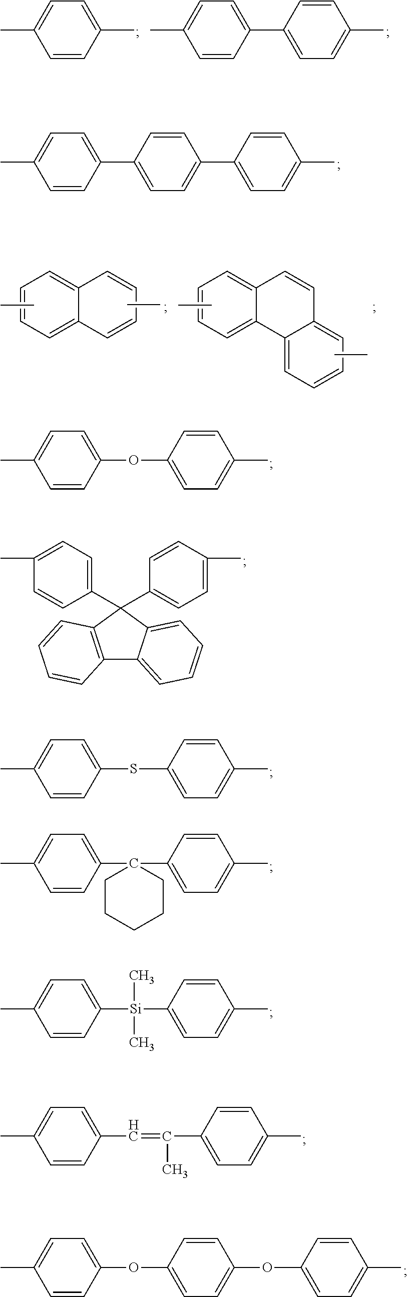

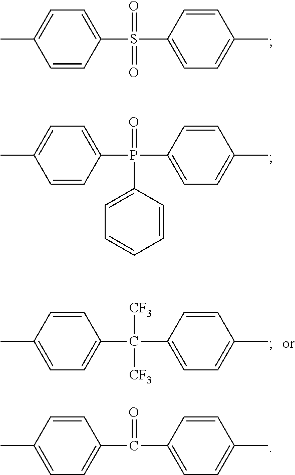

Examples of L₁ include the following linking groups:

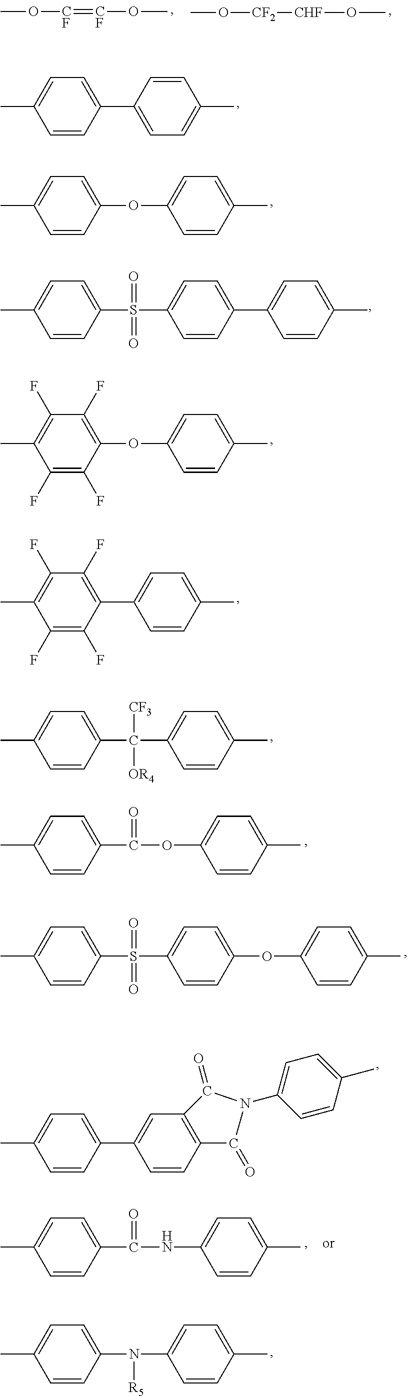

where R₅ is an organic group, such as an alkyl or acyl group.

In another embodiment, the fiber-containing and/or the fiber-free layers include a perfluorosulfonic acid polymer (PFSA). In a refinement, such PFSAs are a copolymer containing a polymerization unit based on a perfluorovinyl compound represented by:

CF₂═CF—(OCF₂CFX¹)ₘ—Oᵣ—(CF₂)_{q}—SO₃H

where m represents an integer of from 0 to 3, q represents an integer of from 1 to 12, r represents 0 or 1, and X¹ represents a fluorine atom or a trifluoromethyl group and a polymerization unit based on tetrafluoroethylene.

The following examples illustrate the various embodiments of the present invention. Those skilled in the art will recognize many variations that are within the spirit of the present invention and scope of the claims.

The orientation of the nanofiber additives inside of the reinforced layers are well controlled in a in-plane direction. The nanofiber materials can be organic (e.g., polymer) or inorganic (e.g., carbon, metal oxide). An MEA with such a membrane demonstrates improved fuel cell durability.

Examples of multi-layer membranes are shown in FIG. 2. Reinforced layers are coated from solutions containing ionomer and nanofiber materials, while the non-reinforced layers are coated from solutions containing ionomer materials. One example (example 1) of developing the multilayer membranes includes the following procedure:

(1). Prepare Coating Solution Containing Nanofiber and Ionomer.

Certain amounts of nanofiber (carbon nanofiber in this example) and ionomer solution (Nafion® DE2020 in this example) are added into a solvent with stirring. Suitable solvents include one or more of water, alcohols, and other organic additives. The concentration of nanofiber and ionomer, as well as the weight ratio of nanofiber to ionomer, can be adjusted by adding different amounts of solvent. In this example, the obtained solution has the ratio of nanofiber to ionomer in the range from 1:20 to 1:2 by weight, to get 5 to 35 wt % of nanofiber additives inside of the dry reinforced layers. Diluted Nafion® solutions without additives are also prepared with 5-20 wt % concentration.

(2). Prepare Multilayer Membranes.

An Erichsen coater with 10-inches by 15 inches of active membrane coating area is applied for membrane preparation. The membranes are coated on a backer film (e.g., 50 μm polytetrafluoroethylene film from Saint-Gobain). The multilayer membranes are prepared via a layer by layer procedure, or by a single step procedure with the coating height adjusted for each layer. Bird applicator (Paul E. Gardner Co.) with selected slot thickness (in the range of 25-150 μm) is used to coat each specific membrane layer, which is achieved by applying coating solutions containing an ionomer or a mixture of ionomer and nanofiber additives. The thickness of each membrane layer is controlled by the height of the Bird applicator slot which determines the amount of solution applied, and the concentration of the coating solution. For the layer by layer procedure applied in this example, to ensure in-plane direction of the nanofiber additives, multi coating passes are conducted for the reinforced layer, and the obtained thickness of each pass is less than 2 μm after drying.

For purposes of comparison, single layer membranes are also prepared without nanofiber additives. The total thickness of all membranes in this example are controlled around 20 μm. The obtained multilayer membranes are then dried at 25° C., 50% RH for 30 min, then heat treated at a temperature typically between 250 to 300° F. for one to twelve hours.

Dimensional Stability.

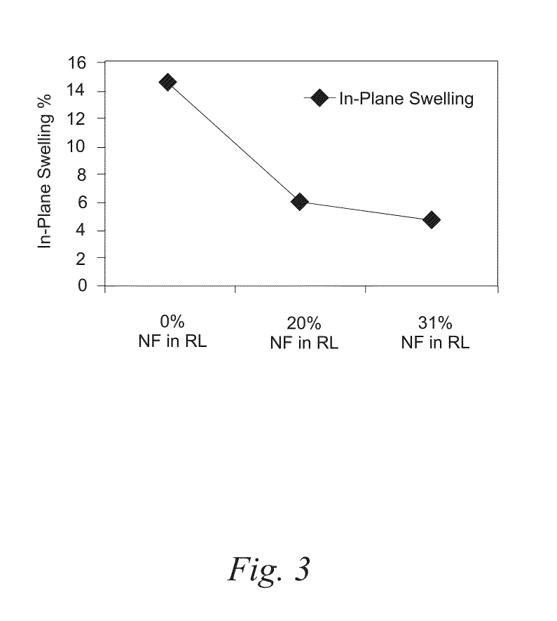

Membrane swelling characterizations are performed on the membranes prepared through the above procedure. The membranes are cut into rectangle pieces at a certain size (e.g., 50.8×25.4 mm). The membrane is placed in a 100° C. oven to dry overnight. The membrane is removed and placed in a pre-weighed receiving jar. The jar is closed and weighed with and without the membrane to get the dry weight of the membrane sample. Alternatively, an analytical moisture balance may be used with a peak temperature of 100° C. for measuring the membrane sample dry weight. The membrane is removed and placed between thin Mylar sheets. Dry x-y-z dimensions are measured. The membrane is placed in a suitable sized vial with DI water at room temperature (record room temperature) and allowed to remain in water for 24 hours. The membranes are removed from the water and the wet weight and x-y-z dimensions are measured. The above steps are repeated with DI water at 60, 80, 100, and 120° C., respectively, to get the weight and x-y-z dimension changes at each condition. FIG. 3 shows the results of in-plane (biaxial, or x-y dimension) swelling of membranes without and with reinforced layer containing various loadings of nanofiber additives, after 24 hours immersed in 80° C. DI water. The in-plane swelling is about 15% for membrane without the reinforced layer, while the in-plane swelling is decreased to 6% and 4.6% by introducing reinforced layer containing 20% and 31% of nanofiber additives, respectively. The decreased in-plane membrane swelling inhibits membrane buckling, folding and cracking inside of fuel cells, by which increases fuel cell durability.

MEA Preparation.

The membranes (single layer or multilayers) obtained through the above procedure are assembled into membrane electrode assembly (MEA). The MEA can optionally include a subgasket positioned between the PEM and the catalyst coated gas diffusion media (GDM) on one or both sides. The subgasket has the shape of a frame, and the size of the window is smaller than the size of the catalyst coated GDM and the size of the PEM. In this example, Pt/Vulcan is used to form the electrocatalyst layer and has a Pt loading of 0.4 mg/cm² at the cathode and 0.05 mg/cm² at the anode. The resulting MEA can then be placed between other parts which may include a pair of gas flow field plates, current collector, and end plates, to form a single fuel cell.

Membrane Through-Plane Resistance and Proton Conductivity Tests.

Through-plane resistances of membranes are measured through Electrochemical (AC) impedance spectra, (Jiang, R., Mittelsteadt, C. M. and Gittleman, C. S., “Through-Plane Proton Transport Resistance of Membrane and Ohmic Resistance Distribution in Fuel Cells”, J. Electrochem. Soc., 156 (2009) B1440-B1446) and the corresponding proton conductivities are calculated from the resistance value. AC impedance spectra are obtained using a Zahner iM6e Impedance Measurement Unit (Zahner Messtechnik, Germany) with a Zaher PP240 booster (Zahner Messtechnik, Germany). Five spectra are obtained at each test condition to check for reproducibility. Tests are conducted over a range of temperatures (40-95° C.) and relative humidity (RH) (20%, 35%, 50%, 75%, 95% and oversaturated) conditions. For each test condition, the cell is equilibrated at the operating condition for over one hour before conducting the AC impedance measurements.

The membrane conductivity, σ, in Siemens per centimeter (S/cm) is calculated by the following equation:

σ=L/(A×R_{membrane}) (1),

where L is the thickness of the membrane in cm, A is the active area in cm², and R_{membrane} is the measured resistance in Ω.

For the reinforced membranes, the sandwich structure with two ionomer (non-reinforced) layers at the outside and a reinforced layer in the middle is considered as a combination of resistors, which represent different component layers. In this study, Rᵢ is used to represent the resistance of each ionomer (non-reinforced) layer resistor, Rₛ represents the resistance of the reinforced layer resistor. The conductivity of the ionomer (non-reinforced) layer and the reinforced layer is defined as σᵢ and σₛ, respectively.

The through-plane resistance of the multilayer membrane, Rₜₕ₋ₚₗ, can be written as:

Rₜₕ₋ₚₗ=Rᵢ+Rₛ+Rᵢ=2×Rᵢ+Rₛ (2)

The corresponding through-plane conductivity is written as:

σₜₕ₋ₚₗ⁻¹=σᵢ⁻¹×2×Lᵢ/L+σₛ⁻¹×Lₛ/L (3).

The through-plane conductivity of the multilayer membrane, σₜₕ₋ₚₗ, is calculated from the resistance measured to the whole membrane through Equation (1). The conductivity of the ionomer layer, σ_{i, is} calculated from the resistance of non-reinforced membrane also using Equation (1). The conductivity of the reinforced layer, σₛ, is then calculated using Equation (3). Because the reinforced layer is a composite membrane layer containing ionomer and nanofiber additives, its conductivity, σₛ, can be written in terms of ionomer layer conductivity, σᵢ:

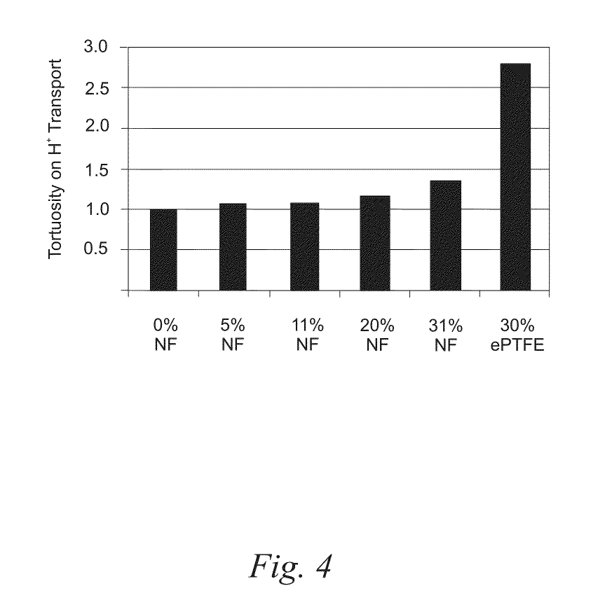

σₛ=σᵢ*ε/τ (4),

where τ represent the tortuosity on proton transport, and ε represents the volume fraction of the ionomer inside of the reinforced layer, which can be calculated from the nanofiber loading inside of the reinforced layer. FIG. 4 shows the proton transport tortuosity, τ, as a function of nanofiber loadings inside of the reinforced layer. A slight increase of proton transport tortuosity is observed with increasing of nanofiber loadings. As a comparison, a reinforced layer with continuous ePTFE (Expanded Polytetrafluoroethylene) additive, with 30% volume ratio in the reinforced layer, is also showed in FIG. 4. As indicated in FIG. 4, with the same volume ratio of additives in the reinforced layer, the proton transport tortuosity of reinforced layer with nanofiber additives is much smaller than that with continuous ePTFE additive. Higher proton transport tortuosity induces larger resistance for proton conduction. Therefore, the nanofiber additives sacrifice the proton conductivity of the reinforced layer to a lesser extent than that with continuous ePTFE additives.

Fuel Cell Durability by RH Cycling Tests.

RH cycling tests without load are conducted to evaluate the mechanical durability of MEAs containing membranes with and without reinforced layers. For each test, 50 cm² active area graphite plates with 2 mm width straight channels and lands are used for cell build. The RH cycling test are conducted at 80° C., ambient outlet gas pressure, 20 SLPM constant flow rate of air is introduced in both the anode and cathode of the cell in counter-flow format. The air supplies to anode and cathode are periodically passed or by-passed through humidifiers controlled at 90° C., to achieve 150% RH and 0% RH with duration of 2 min at each condition. The MEA failure criteria is arbitrarily defined as 10 sccm crossover gas leak from anode to cathode or vice versa. The target of the RH cycling test to a MEA is to achieve 20,000 RH cycles with less than 10 sccm crossover gas leak.

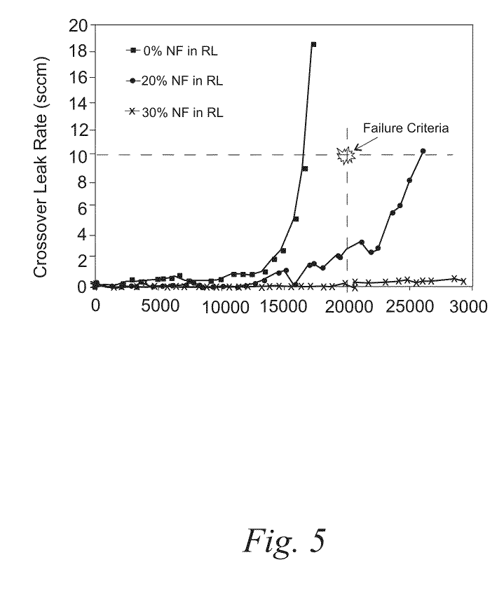

The results of RH cycling tests are shown in FIG. 5. The MEA containing membrane without reinforced layer fails in the tests with over 10 sccm gas leak and less than 20,000 cycles. Both of the two MEAs containing multilayer membranes with nanofiber additives (20% and 31% loadings) in the reinforced layer pass the test criteria. The MEA with 31% of nanofiber in the reinforced layer even successfully passed 30000 (1.5× of the criteria) cycles with little gas leak. The reinforced layers containing nanofiber additives improve fuel cell durability by enhancing membrane mechanical stability.

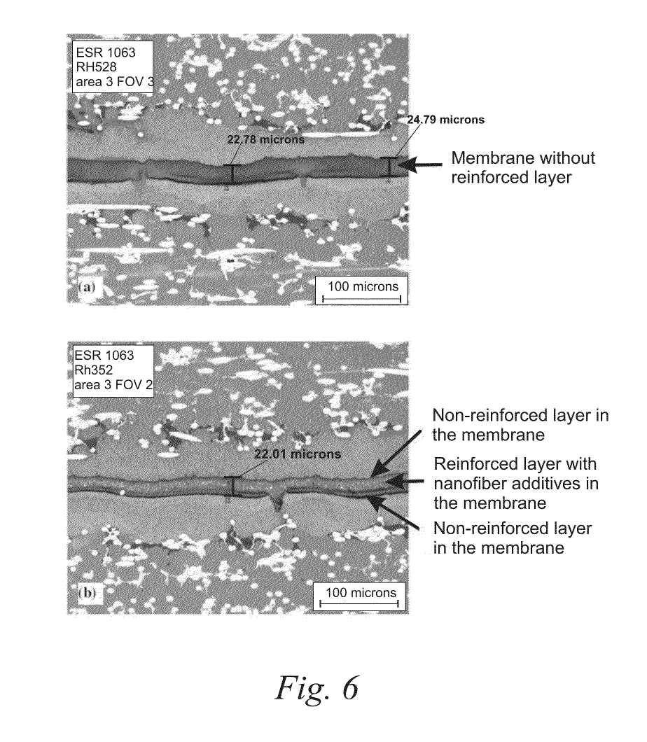

The cross sections of the above MEAs were examined using Scanning Electron Microscopy (SEM). FIG. 6 shows the cross section of MEAs after the RH cycling tests. The MEA without the reinforced layer shows significant membrane cracking and damage between the anode and cathode electrode layers. For membrane containing reinforced layer with nanofiber additives, membrane damage was inhibited by the reinforced layer. Comparing to membrane without reinforced layer, the multilayer membranes with reinforced layers demonstrated improved fuel cell operation by enhancing membrane mechanical stability.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An ion-conducting membrane for a fuel cell, the ion-conducting membrane comprising:
a first layer including a first ion-conducting polymer and nanofibers, the nanofibers being dispersed within the first ion-conducting polymer, the first layer including a first side and a second side;
a second layer disposed over the first side of the first layer including a second ion-conducting polymer without nanofibers.

2. The ion-conducting membrane of claim 1 wherein the first ion-conducting polymer and the second ion-conducting polymer each independently comprise a component selected from the group consisting of perfluorosulfonic acid polymer, hydrocarbon based ionomer, sulfonated polyether ether ketone polymer, perfluorocyclobutane polymers, and combinations thereof.

3. The ion-conducting membrane of claim 1 wherein the nanofibers are polymeric nanofibers or inorganic nanofibers.

4. The ion-conducting membrane of claim 1 wherein the nanofibers comprise a component selected from the group consisting of polyvinylidene fluoride, polyester, and combinations thereof.

5. The ion-conducting membrane of claim 1 wherein the nanofibers comprise a component selected from the group consisting of carbon, metal, ceramic oxide/composites, CeO₂, MnO₂, TiO₂, ZrO₂, SiO₂, Al₂O₂, ZrCeO₂, and combinations thereof.

6. The ion-conducting membrane of claim 1 wherein the nanofibers have a continuous web configuration.

7. The ion-conducting membrane of claim 1 wherein the nanofibers comprise discrete individual fibers.

8. The ion-conducting membrane of claim 1 wherein the nanofibers are electrically conductive or electrically non-conductive

9. The ion-conducting membrane of claim 1 wherein the nanofibers have an average length greater than about 10 nm and an average diameter from about 5 nm to about 10 μm.

10. The ion-conducting membrane of claim 1 wherein the first layer includes nanofibers in an amount from about 1 to about 50 weight percent of the total weight of the first layer.

11. The ion-conducting membrane of claim 1 wherein the nanofibers have an in-plane oriention.

12. The ion-conducting membrane of claim 1 wherein the first layer has moisture-induced swelling less than about 10 percent.

13. The ion-conducting membrane of claim 1 further comprising a third layer disposed over and contacting the second side of the first layer, the third layer including a third ion-conducting polymer without nanofibers.

14. The ion-conducting membrane of claim 1 further comprising a third layer disposed over and contacting the second layer, the third layer including a third ion-conducting polymer and nanofibers, the nanofibers being dispersed within the third ion-conducting polymer.

15. A membrane electrode assembly for fuel cells, the membrane electrode assembly comprising:
an anode layer;
a cathode layer;
an ion-conducting membrane interposed between the anode layer and the cathode layer, the ion-conducting membrane comprising:
a first layer including a first ion-conducting polymer and nanofibers, the nanofibers being dispersed within the first ion-conducting polymer, the first layer including a first side and a second side;
a second layer disposed over the first side of the first layer including a second ion-conducting polymer without nanofibers.

16. The membrane electrode assembly of claim 15 wherein the first ion-conducting polymer and the second ion-conducting polymer each independently comprise a component selected from the group consisting of perfluorosulfonic acid polymer, hydrocarbon based ionomer, sulfonated polyether ether ketone polymer, perfluorocyclobutane polymers, and combinations thereof.

17. The membrane electrode assembly of claim 15 wherein the nanofibers are polymeric nanofibers or inorganic nanofibers.

18. The ion-conducting membrane of claim 15 wherein the nanofibers comprise a component selected from the group consisting of polyvinylidene fluoride, polyester, and combinations thereof.

19. The membrane electrode assembly of claim 15 wherein the nanofibers comprise a component selected from the group consisting of carbon, metal, ceramic oxide/composites, CeO₂, MnO₂, TiO₂, ZrO₂, SiO₂, Al₂O₂, ZrCeO₂, and combinations thereof.

20. The membrane electrode assembly of claim 15 wherein the nanofibers have a continuous web configuration.

21. The membrane electrode assembly of claim 15 wherein the nanofibers comprise discrete individual fibers.

22. The membrane electrode assembly of claim 15 wherein the nanofibers are electrically conductive or electrically non-conductive

23. The membrane electrode assembly of claim 15 wherein the nanofibers have an average length greater than about 10 nm and an average diameter from about 5 nm to about 10 μm.

24. The membrane electrode assembly of claim 15 wherein the first layer includes nanofibers in an amount from about 1 to about 50 weight percent of the total weight of the first layer.

25. The membrane electrode assembly of claim 15 wherein the nanofibers have an in-plane orientation.

26. The membrane electrode assembly of claim 15 further comprising a third layer disposed over and contacting the second side of the first layer, the third layer including a third ion-conducting polymer without nanofibers.

27. The membrane electrode assembly of claim 15 further comprising a third layer disposed over and contacting the second layer, the third layer including a third ion-conducting polymer and nanofibers, the nanofibers being dispersed within the third ion-conducting polymer.
